(19) United States
(12) Patent Application Publication
(10) Pub. No.: US 2015/0052470 A1
(43) Pub. Date: Feb. 19, 2015

(54) METHOD AND APPARATUS FOR DISPLAYING MEDICAL IMAGE

(71) Applicant: SAMSUNG ELECTRONICS CO., LTD., Suwon-si (KR)

(72) Inventors: Hei-soog KIM, Anyang-si (KR); Jong-hyun SHIN, Seoul (KR); Hyug-rae CHO, Seoul (KR)

(73) Assignee: SAMSUNG ELECTRONICS CO., LTD., Suwon-si (KR)

(21) Appl. No.: 14/250,795

(22) Filed: Apr. 11, 2014

(30) Foreign Application Priority Data
Aug. 19, 2013 (KR) 10-2013-0098128

(51) Int. Cl. G06F 19/00; G06F 17/30; G06F 3/0484

(52) U.S. Cl. CPC G06F 19/321; G06F 3/04847; G06F 17/30277
USPC 715/771

(57) ABSTRACT

A method for displaying a medical image includes: displaying a slide bar including a speed adjustment button; receiving a selection input and a drag input for the speed adjustment button from a user; determining a search direction and a search speed for the medical images based on the drag input; and searching for all or some of the medical images according to the determined search direction and search speed, and displaying the medical images which have been searched for.

### CROSS-REFERENCE TO RELATED APPLICATION

This application claims priority from Korean Patent Application No. 10-2013-0098128, filed on Aug. 19, 2013, in the Korean Intellectual Property Office, the disclosure of which is incorporated herein in its entirety by reference.

### BACKGROUND

1. Field

Apparatuses and methods consistent with exemplary embodiments relate to medical imaging, and more particularly, to displaying a medical image.

2. Description of the Related Art

Medical imaging apparatuses acquire images of an internal structure of an object, as for example, to show the structural details, internal tissue, and fluid flow of a human body. Examples of medical imaging apparatuses include magnetic resonance imaging (MRI) apparatuses, computed tomography (CT) apparatuses, ultrasonic apparatuses, X-ray apparatuses, etc.

Generally, medical imaging apparatuses acquire a plurality of medical images of the object, for diagnosing the object from various perspectives.

However, when there are many medical images, a user is inconvenienced in checking the medical images. For example, when a user desires to check a specific medical image, the user cannot easily find the specific medical image from a great number of medical images.

Therefore, a method of displaying a plurality of medical images is needed for enhancing a user's convenience in viewing a specific image.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

One or more exemplary embodiments include a medical image displaying method and apparatus that enable a user to conveniently check a plurality of medical images.

According to one or more exemplary embodiments, a method of displaying a plurality of medical images, which are arranged in a certain order, includes: displaying a slide bar including a speed adjustment button; receiving a selection input and a drag input for the speed adjustment button from a user; determining a search direction and a search speed for the plurality of medical images on a basis of the drag input; and sequentially searching for all or some of the plurality of medical images according to the determined search direction and search speed, and displaying the searched medical images.

The determining of a search direction and a search speed may include: when the speed adjustment button moves in a first direction according to the drag input, determining the search direction as a forward direction of the certain order; and when the speed adjustment button moves in a second direction, determining the search direction as a reverse direction of the certain order.

The determining of a search direction and a search speed may include, when the speed adjustment button disposed at a first position of the slide bar moves to a second position of the slide bar according to the drag input, determining the search speed on a basis of a distance between the first position and the second position.

The method may further include, when the drag input performed by the user ends, stopping searching for the plurality of medical images.

The method may further include: displaying a first medical image of the plurality of medical images; and overlapping and displaying number of the medical images and an order in which the first medical image of the plurality of medical images is arranged, on the speed adjustment bar.

The method may further include: receiving an input “N” (where N is an arbitrary integer) from the user; and displaying a medical image arranged at an Nth-order position among the plurality of medical images.

The speed adjustment button may include a first sub-button and a second sub-button. The method may further include: displaying a first medical image of the plurality of medical images; receiving the user's selection input for the first sub-button or the second sub-button; and displaying a second medical image arranged at a position previous to the first medical image among the plurality of medical images on a basis of the user's selection input for the first sub-button, or displaying a third medical image arranged at a position subsequent to the first medical image among the plurality of medical images on a basis of the user's selection input for the second sub-button.

The first direction may include an up direction, a down direction, a left direction, or a right direction, and the second direction may include a direction opposite to the first direction.

According to one or more exemplary embodiments, an apparatus for displaying a plurality of medical images, which are arranged in a certain order, includes: an output unit that displays a slide bar including a speed adjustment button; a user input receiver that receives a selection input and a drag input for the speed adjustment button from a user; and a controller that determines a search direction and a search speed for the plurality of medical images on a basis of the drag input, and by controlling the controller, allows the output unit to sequentially search for all or some of the plurality of medical images according to the determined search direction and search speed, and to display the searched medical images.

When the speed adjustment button moves in a first direction according to the drag input, the controller may determine the search direction as a forward direction of the certain order, and when the speed adjustment button moves in a second direction, the controller may determine the search direction as a reverse direction of the certain order.

When the speed adjustment button disposed at a first position of the slide bar moves to a second position of the slide bar according to the drag input, the controller may determine the search speed on a basis of a distance between the first position and the second position.

When the drag input performed by the user ends, the apparatus may stop searching for the plurality of medical images.

The apparatus may display a first medical image of the plurality of medical images, and overlap and display number of the medical images and an order in which the first medical image of the plurality of medical images is arranged, on the speed adjustment bar.

The apparatus may receive an input “N” (where N is an arbitrary integer) from the user, and display a medical image arranged at an Nth-order position among the plurality of medical images.

The speed adjustment button may include a first sub-button and a second sub-button. The apparatus may display a first medical image of the plurality of medical images, receive the user's selection input for the first sub-button or the second sub-button, and display a second medical image arranged at a position previous to the first medical image among the plurality of medical images on a basis of the user's selection input for the first sub-button, or display a third medical image arranged at a position subsequent to the first medical image among the plurality of medical images on a basis of the user's selection input for the second sub-button.

The first direction may include an up direction, a down direction, a left direction, or a right direction, and the second direction may include a direction opposite to the first direction.

According to one or more exemplary embodiments, there is provided a non-transitory computer-readable storage medium storing a computer program for executing the method.

### BRIEF DESCRIPTION OF THE DRAWINGS

The above and/or other aspects will become more apparent by describing certain exemplary embodiments, with reference to the accompanying drawings, in which:

FIG. 1 is a block diagram illustrating a configuration of a medical image displaying apparatus according to an exemplary embodiment;

FIGS. 2A, 2B, and 2C are diagrams for describing an exemplary method of displaying a plurality of medical images;

FIG. 3 is a diagram for describing a method of displaying a plurality of medical images, according to an exemplary embodiment;

FIGS. 4A and 4B are diagrams for describing a method of searching for images by using a speed adjustment slide bar, according to an exemplary embodiment;

FIGS. 5A, 5B, and 5C are diagrams for describing a method of searching for images by using a speed adjustment slide bar, according to an exemplary embodiment;

FIG. 6 is a diagram for describing a method of displaying a slide bar, according to an exemplary embodiment;

FIGS. 7A and 7B are diagrams for describing a method of displaying a slide bar, according to an exemplary embodiment;

FIG. 8 is a flowchart of a medical image displaying method according to an exemplary embodiment;

FIG. 9 is a diagram illustrating a configuration of a medical image displaying apparatus according to an exemplary embodiment; and

FIG. 10 is a diagram illustrating a configuration of a communicator.

### DETAILED DESCRIPTION

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

As used herein, the term “and/or” includes any and all combinations of one or more of the associated listed items. Expressions such as “at least one of,” when preceding a list of elements, modify the entire list of elements and do not modify the individual elements of the list.

In the disclosure below, when it is described that one comprises (or includes or has) some elements, it should be understood that it may comprise (or include or has) only those elements, or it may comprise (or include or have) other elements as well as those elements if there is no specific limitation. The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The term “image” used herein may denote multi-dimensional data composed of discrete image factors (for example, pixels in a two-dimensional (2D) image and pixels in a three-dimensional (3D) image). For example, an image may include a medical image of an object which is acquired by an optical acoustic apparatus.

The term “object” used herein may include a person, an animal, a part of the person, or a part of the animal. For example, an object may include an organ such as a liver, a heart, a womb, a brain, breasts, an abdomen, or the like, or a blood vessel. Also, the term “object” may include a phantom. The phantom denotes a material having a volume that is very close to a density of organisms and an effective atomic number, and may include a spherical phantom having a temper similar to a human body.

The term “user” used herein is a medical expert, and may be a doctor, a nurse, a medical technologist, a medical image expert, or the like, or may be an engineer repairing a medical apparatus. However, the user is not limited thereto.

Moreover, the term “magnetic resonance imaging (MRI)” used herein denotes an image of an object which is obtained by using the nuclear magnetic resonance principle.

A medical image displaying method and apparatus according to an exemplary embodiment quickly and accurately search for a plurality of medical images by using a speed adjustment slide bar.

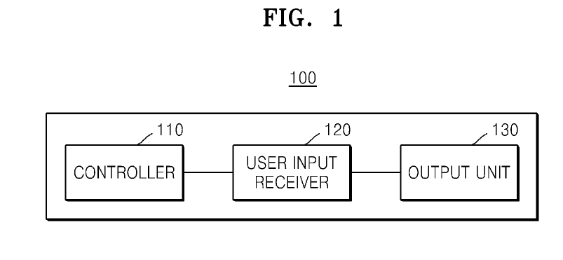

FIG. 1 is a block diagram illustrating a configuration of a medical image displaying apparatus 100 according to an exemplary embodiment.

Referring to FIG. 1, the medical image displaying apparatus 100 according to an exemplary embodiment may include a controller 110, a user input receiver 120, and an output unit 130, i.e., a display. The medical image displaying apparatus 100 may display a plurality of medical images which are arranged in a certain order, depending on predetermined references such as an acquisition time, an image file size, etc.

The output unit 130 may display a slide bar including a speed adjustment bar. A speed adjustment button may be arranged at, as an initial position, a first position of the slide bar. Also, the output unit 130 may display a medical image, corresponding to the initial position of the speed adjustment button, among the plurality of medical images.

The output unit 130 may include a display. The output unit 130 may display the slide bar in a first region of a screen of the display, and display the plurality of medical images at a second region.

The user input receiver 120 receives a certain input from a user. For example, the user input receiver 120 may receive a user's selection input for the speed adjustment button, and receive the user's drag input for the speed adjustment button. The user may perform the selection input and the drag input for the speed adjustment button displayed by the output unit 130 by using a mouse, a trackball, a keyboard, or a touch screen.

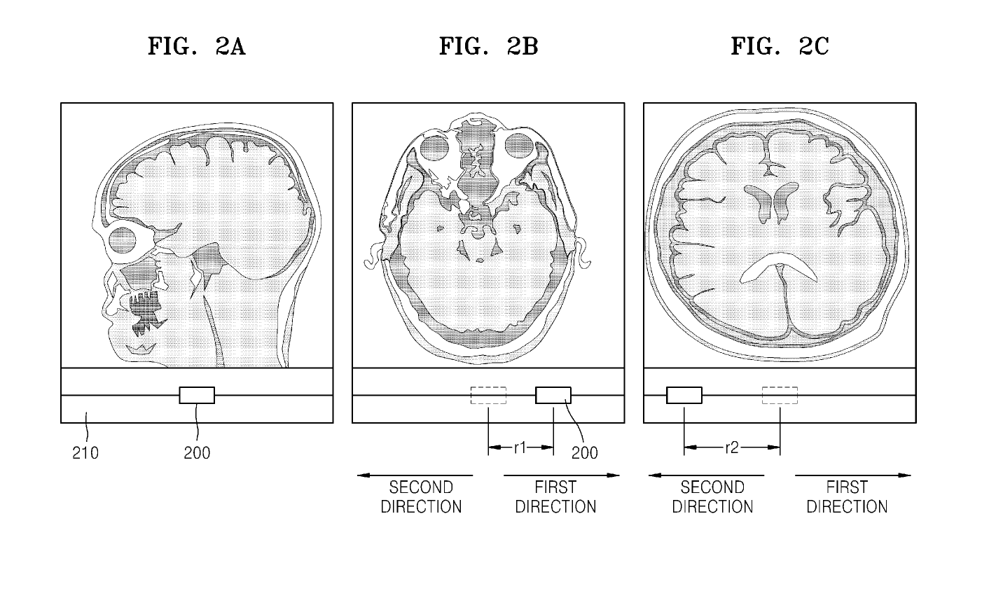

The controller 110 determines a search direction and a search speed for a plurality of medical images on the basis of the drag input, and by controlling the output unit 130, the controller 110 allows the output unit 130 to sequentially search for the plurality of medical images according to the search direction and the search speed, and to display the searched medical images. A method of determining the search direction and the search speed will be described in detail with reference to FIGS. 2A, 2B, and 2C.

FIGS. 2A, 2B, and 2C are diagrams for describing an exemplary method of displaying a plurality of medical images. FIGS. 2A, 2B, and 2C all illustrate a slide bar, including a speed adjustment button, and the output unit 130 that displays one of a plurality of medical images.

Referring to FIG. 2A, a speed adjustment button 200 is arranged at a first position of the slide bar. A user may select the speed adjustment button 200 displayed by the output unit 130, and perform a drag input that drags the speed adjustment button 200 in a first direction or a second direction.

The controller 110 may determine a search direction for a plurality of medical images on the basis of a moving direction of the speed adjustment button 200. For example, when the speed adjustment button 200 is moved in the first direction by the drag input, the controller 110 may determine a search direction for a plurality of medical images, which are arranged in a certain order, as a forward direction of the certain order. On the other hand, when the speed adjustment button 200 is moved in the second direction by the drag input, the controller 110 may determine the search direction for the plurality of medical images as a reverse direction of the certain order.

FIG. 2B is a diagram illustrating a state in which the speed adjustment button 200 moves from the first position to a second position along the first direction on the basis of the user's drag input.

As illustrated in FIG. 2B, since the speed adjustment button 200 has been moved in the first direction by the user's drag input, the controller 110 may determine the forward direction of the certain order as a search direction. The output unit 130 sequentially searches for all or some of the plurality of medical images in the forward direction of the certain order, and displays the searched medical images. For example, a medical image illustrated in FIG. 2A is a medical image which is arranged at a fifth-order position among the plurality of medical images. When the search direction is determined as the forward direction of the certain order, the output unit 130 may sequentially search for sixth to nth medical images (where n is the number of medical images), and display the searched medical images.

FIG. 2C is a diagram illustrating a state in which the speed adjustment button 200 moves from the first position to a second position along the second direction by the user's drag input.

As illustrated in FIG. 2C, since the speed adjustment button 200 has been moved in the second direction by the user's drag input, the controller 110 may determine the reverse direction of the certain order as a search direction. The output unit 130 sequentially searches for all or some of the plurality of medical images in the reverse direction of the certain order, and displays the searched medical images. For example, a medical image illustrated in FIG. 2A is a medical image which is arranged at a tenth-order position among the plurality of medical images. When the search direction is determined as the reverse direction of the certain order, the output unit 130 may sequentially search medical images in the order from a ninth medical image to a first medical image, and display the searched medical images.

When the speed adjustment button 200 arranged at the first position is moved to the second position by the user's drag input, the medical image displaying apparatus according to an exemplary embodiment may determine a search speed for the plurality of medical images on the basis of a distance between the first position and the second position. For example, as the distance between the first position and the second position increases, the medical image displaying apparatus 100 may increase the search speed. Referring to FIGS. 2B and 2C, a distance r1 between the first position and the second position in the FIG. 2B is shorter than a distance r2 between the first position and the second position in FIG. 2C, and thus, a search speed for the medical images in FIG. 2B is slower than a search speed for the medical images in FIG. 2C.

A user performs a drag input, and thus easily sets a search direction and a search speed for a plurality of medical images.

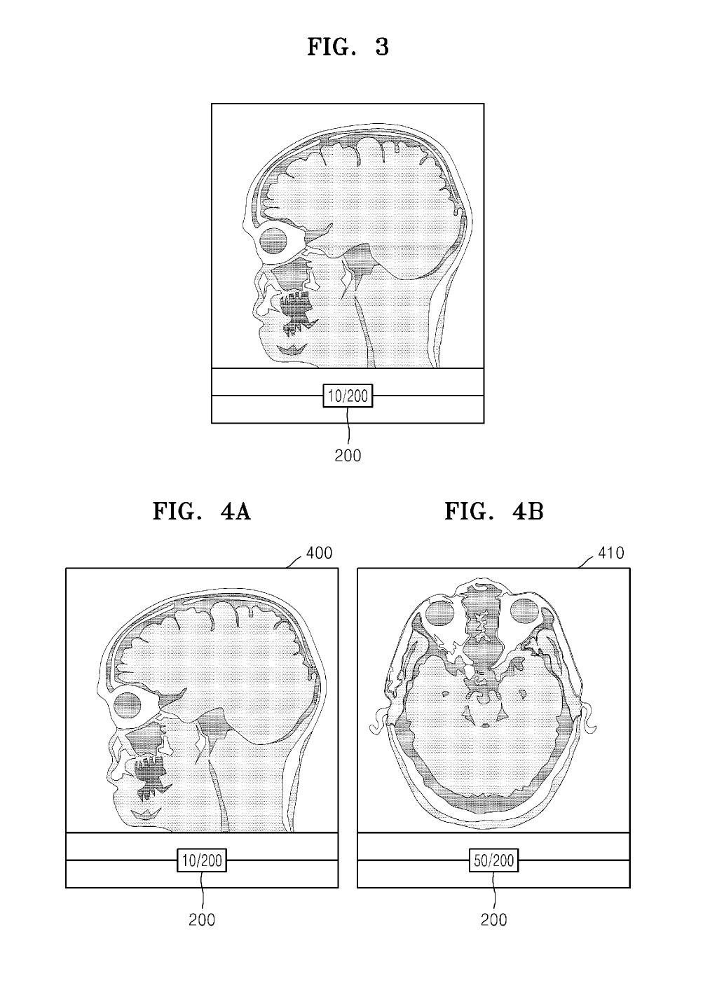

FIG. 3 is a diagram for describing a method of displaying a plurality of medical images, according to an exemplary embodiment.

Referring to FIG. 3, the medical image displaying apparatus may display a number 200, which is the total number of medical images, on the speed adjustment button 200. Also, the medical image displaying apparatus may display an order number 10 of a medical image, which indicates that a currently displayed image is a medical image arranged at a tenth-order position, on the speed adjustment button 200.

FIGS. 4A and 4B are diagrams for describing a method of searching for images by using a speed adjustment slide bar, according to an exemplary embodiment.

Referring to FIGS. 4A and 4B, the medical image displaying apparatus may receive an input “N” (where N is an arbitrary integer) from a user, and display a medical image arranged at an Nth-order position among a plurality of medical images.

Referring to FIG. 4A, the medical image displaying apparatus may display the total number 200 of medical images and a currently displayed image 400 arranged at the Nth-order position, on the speed adjustment button 200. The speed adjustment button 200 may be overlapped on the displayed image 400.

Referring to FIG. 4B, the medical image displaying apparatus may receive an input “50” from the user, and display a medical image 410 currently arranged at a fiftieth-order position out of 200 total medical images.

That is, by moving the slide bar directly from the tenth medical image 400 to the fiftieth medical image 410, a time taken in searching for the medical images is shortened.

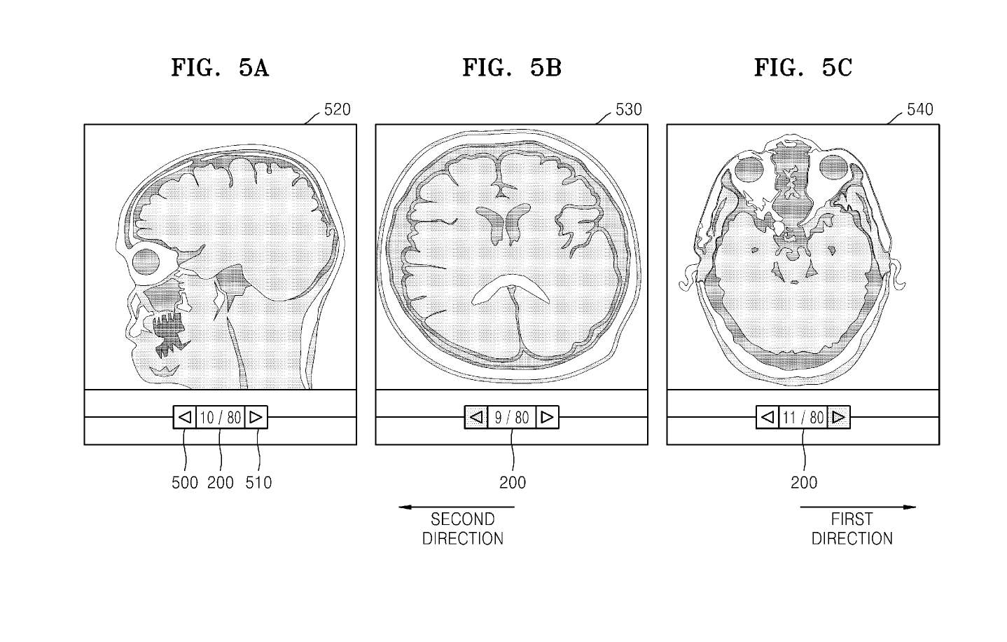

FIGS. 5A, 5B, and 5C are diagrams for describing a method of searching for images by using a speed adjustment slide bar, according to an exemplary embodiment.

Referring to FIGS. 5A, 5B, and 5C, the speed adjustment button 200 includes a first sub-button 500 and a second sub-button 510.

The medical image displaying apparatus 100 may display a first medical image 520 among a plurality of medical images, and receive a user's input for the first sub-button 500 or the second sub-button 510. The medical image displaying apparatus 100 may display a second medical image 530 arranged at a position previous to the first medical image 520 among the plurality of medical images on the basis of the user's input for the first sub-button 500, or display a third medical image 540 arranged at a position subsequent to the first medical image 520 among the plurality of medical images on the basis of the user's input for the second sub-button 510.

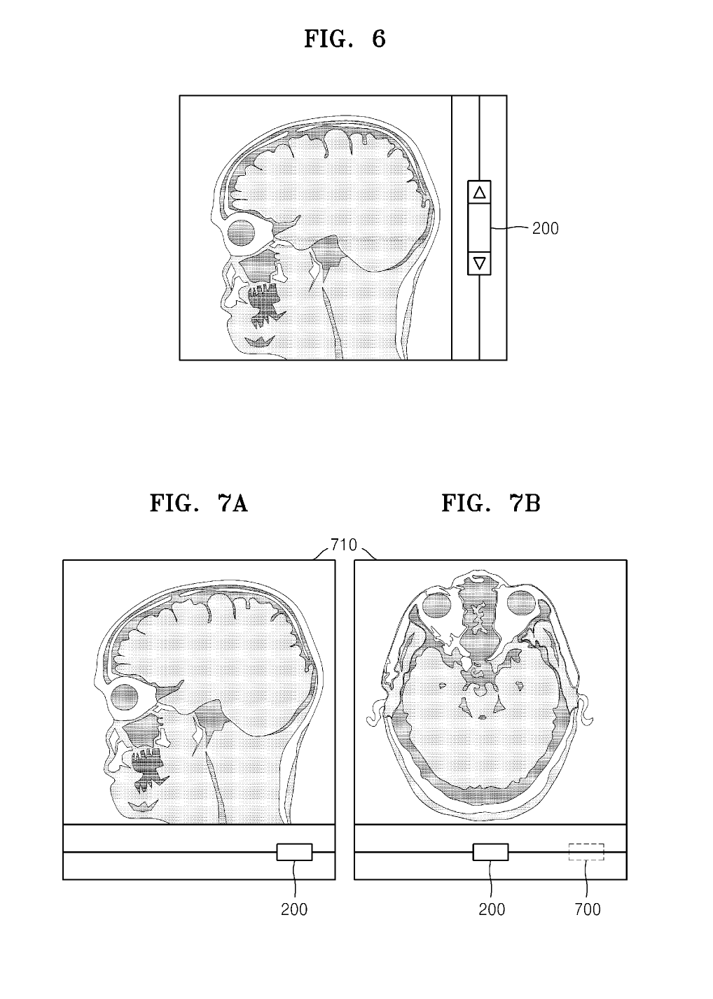

FIG. 6 is a diagram for describing a method of displaying a slide bar, according to an exemplary embodiment.

As described above, the speed adjustment button 200 included in a slide bar 210 may move in a first direction or a second direction. The first direction may include an up direction, a down direction, a left direction, or a right direction, and the second direction may include a direction opposite to the first direction.

Referring to FIG. 6, the first direction may be the up direction, and the second direction may be the down direction opposite to the up direction. Therefore, the speed adjustment button 200 may move in the up direction or the down direction.

FIGS. 7A and 7B are diagrams for describing a method of displaying a slide bar, according to an exemplary embodiment.

Referring to FIGS. 7A and 7B, when a user's drag input ends, the medical image displaying apparatus 100 may stop a search for a plurality of medical images.

Referring to FIGS. 7A and 7B, the speed adjustment button 200 is dragged and moved to a second position 700, and when the user's drag input ends, by stopping searching for the plurality of medical images, a medical image displayed by the display may be displayed as-is, and the speed adjustment button 200 may move to the first position that is the initial position.

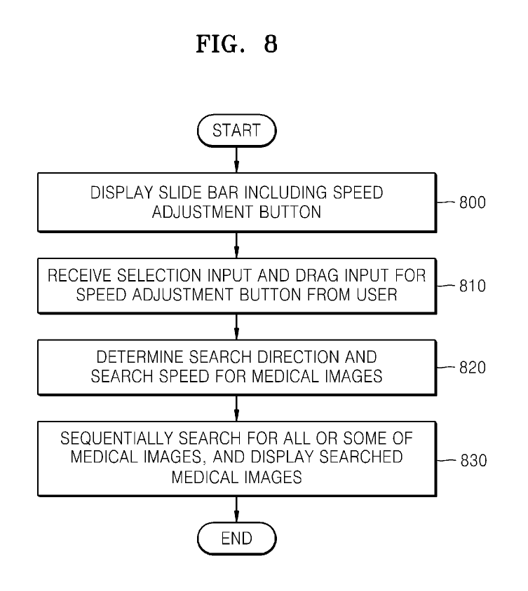

FIG. 8 is a flowchart of a medical image displaying method according to an exemplary embodiment.

Referring to FIG. 8, the medical image displaying method according to an exemplary embodiment includes a plurality of operations that are time-serially performed by the medical image displaying apparatus 100 of FIG. 1. Therefore, although not described below, the descriptions of the medical image displaying apparatus 100 of FIG. 1 above may be applied to the medical image displaying method of FIG. 8.

In operation 800, the output unit 130 may display the slide bar 210 including the speed adjustment button 200.

The speed adjustment button 200 may be arranged at the first position of the slide bar 210. The first position may be the central position of the slide bar 210, but is not limited thereto.

In operation 810, the user input receiver 120 may receive a drag input for the speed adjustment button 200 from the user.

The drag input for the speed adjustment button 200 may be performed by clicking a mouse, or when the display has a function of a touch pad, the drag input may be performed through a touch. However, the drag input is not limited thereto.

In operation 820, the controller 110 may determine a search direction and a search speed for a plurality of medical images on the basis of the drag input.

When the speed adjustment button 200 is moved in the first direction by the drag input, the controller 110 may determine the search direction as the forward direction, and when the speed adjustment button 200 is moved in the second direction by the drag input, the controller 110 may determine the search direction as the reverse direction. The search speed may vary according to the distance between the first position and the second position. As the distance between the first position and the second position increases, the controller 110 may gradually increase the search speed.

Alternatively, scale markings may be given to the slide bar 210, and thus, an image search speed may be designated for each scale marking.

In operation 830, the controller 110 may determine the search direction and the search speed for the plurality of medical images on the basis of the drag input, and by controlling the output unit 130, the controller 110 may allow the output unit 130 to sequentially search for all or some of the plurality of medical images according to the search direction and the search speed, and to display the searched medical images.

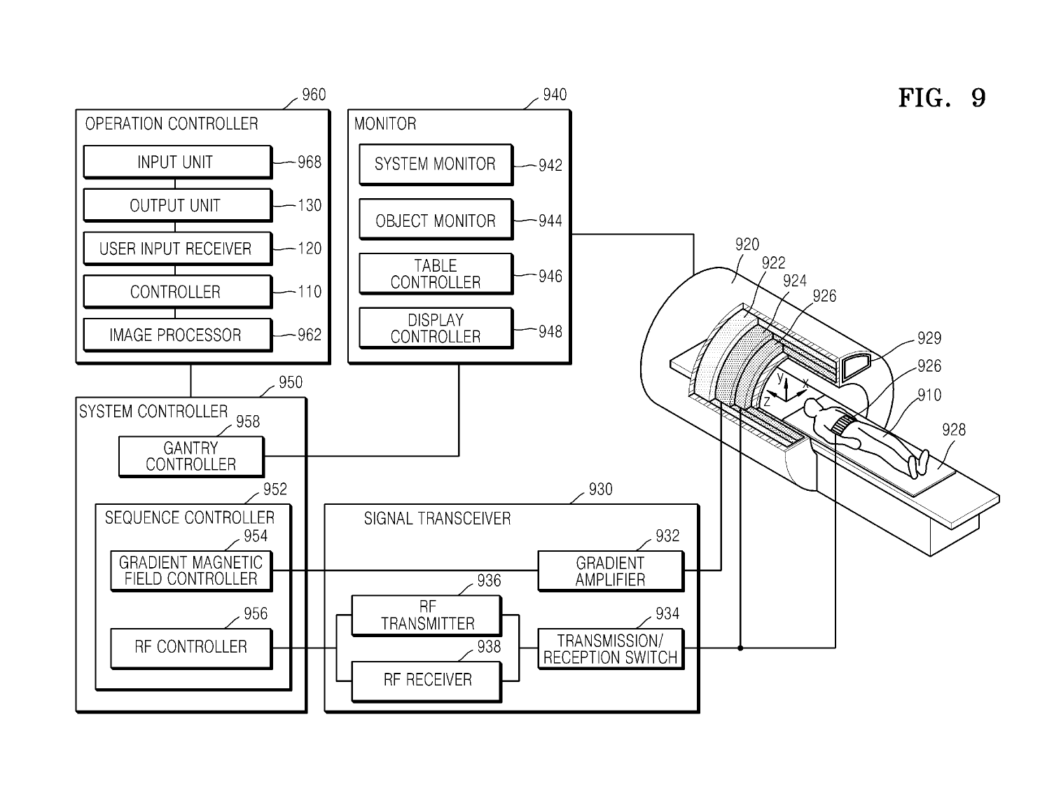

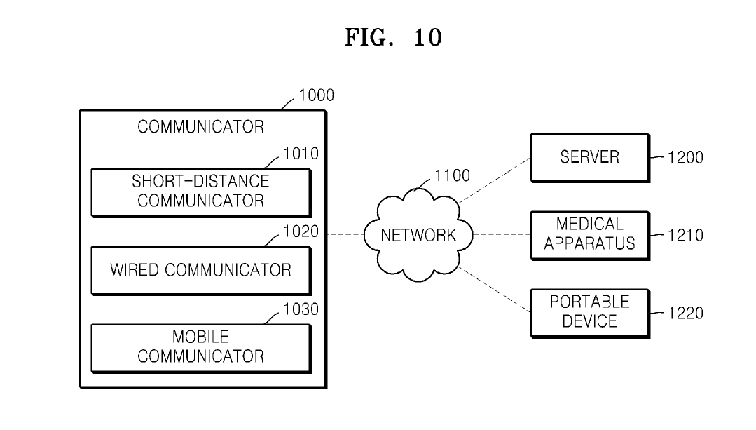

FIG. 9 is a diagram illustrating a configuration of a medical image displaying apparatus according to an exemplary embodiment.

Referring to FIG. 9, an MRI system may include a gantry 920, a signal transceiver 930, a monitor 940, a system controller 950, and an operation controller 960.

The gantry 920 prevents an electromagnetic wave, generated by a main magnet 922, a gradient coil 924, and a radio frequency (RF) coil 926, from being emitted to the outside. A static electromagnetic field and a gradient magnetic field are generated at a bore of the gantry 920, and an RF signal is irradiated toward an object 910.

The main magnet 922, the gradient coil 924, and the RF coil 926 may be disposed along a certain direction of the gantry 920. The certain direction may include a coaxial cylinder direction. The object 910 may be located on a table 928 which is insertable into a bore of a gantry cylinder along a horizontal axis of the bore.

The main magnet 922 generates a static electromagnetic field or a static magnetic field for aligning magnetic dipole moments of atomic nucleuses of the object 910 in a constant direction. As the magnetic field generated by the main magnet 922 becomes stronger and more uniform, a relatively precise and accurate MR image of the object 910 is acquired.

The gradient coil 924 includes X, Y, and Z coils that respectively generate gradient magnetic fields in X-axis, Y-axis, and Z-axis directions that are orthogonal to each other. The gradient coil 924 may induce different resonance frequencies for each part of the object 910, and provide position information of each part of the object 910.

The RF coil 926 may irradiate an RF signal on a patient as the object 910, and receive an MR signal emitted from the patient. Specifically, the RF coil 926 may transmit an RF signal, having the same frequency as that of a precessional motion, to the patient toward an atomic nucleus performing the precessional motion, stop the transmission of the RF signal, and receive an MR signal emitted from the patient.

For example, in order to excite a specific atomic nucleus from a low energy level to a high energy level, the RF coil 926 may generate an electromagnetic wave signal (for example, an RF signal) having an RF corresponding to a kind of the specific atomic nucleus, and apply the electromagnetic wave signal to the object 910. When the electromagnetic wave signal generated by the RF coil 926 is applied to a specific atomic nucleus, the specific atomic nucleus may be excited from a low energy level to a high energy level. Then, when the electromagnetic wave signal generated by the RF coil 926 dissipates, an energy level of the atomic nucleus to which the electromagnetic wave is applied may be changed from the high energy level to the low energy level, and an electromagnetic wave having a Larmor frequency may be emitted. The RF coil 926 may receive an electromagnetic wave signal emitted from internal atomic nuclei of the object 910.

The RF coil 926 may be implemented as one RF transmission/reception coil that has a function of generating an electromagnetic wave having an RF corresponding to a kind of atomic nucleus and a function of receiving an electromagnetic wave emitted from the atomic nucleus. Alternatively, the RF coil 926 may be configured with a transmission RF coil that has the function of generating an electromagnetic wave having an RF corresponding to a kind of atomic nucleus and a reception RF coil that has a function of receiving an electromagnetic wave emitted from the atomic nucleus.

Moreover, the RF coil 926 may be fixed to the gantry 920, or is detachably attached to the gantry 920. The attachable/detachable RF coil 926 may include a plurality of RF coils including a head RF coil, a chest RF coil, a leg RF coil, a neck RF coil, a shoulder RF coil, a wrist RF coil, and an ankle RF coil for some parts of an object, depending on a diagnosis part of the object.

Moreover, the RF coil 926 may communicate with an external device in a wired/wireless manner, and perform dual tune communication based on a communication frequency band.

Moreover, the RF coil 926 may include a birdcage coil, a surface coil, and a TEM coil, depending on a shape and structure of a coil.

Moreover, the RF coil 926 may include a transmit only coil, a receipt only coil, and a transmit/receipt coil, depending on an RF signal transmission/reception method.

Moreover, the RF coil 926 may include RF coils of various channels such as 16 channel, 32 channel, 72 channel, and 144 channel.

The gantry 920 may further include a display 929 disposed outside the gantry 920 and a display (not shown) disposed inside the gantry 920. A user may provide certain information to an object by using the displays respectively disposed inside and outside the gantry 920.

The signal transceiver 930 may control a gradient magnetic field which is generated inside (i.e., the bore) the gantry 920, and control transmission/reception of an RF signal and an MR signal, according to a certain MR sequence.

The signal transceiver 930 may include a gradient amplifier 932, a transmission/reception switch 934, an RF transmitter 936, and an RF receiver 938.

The gradient amplifier 932 may drive the gradient coil 924 included in the gantry 920, and supply a pulse signal, used to generate a gradient magnetic field, to the gradient coil 924 according to control by a gradient magnetic field controller 954. Gradient magnetic fields in the X-axis, Y-axis, and Z-axis directions may be synthesized by controlling the pulse signal supplied from the gradient amplifier 932 to the gradient coil 924.

The RF transmitter 936 and the RF receiver 938 may drive the RF coil 926. The RF transmitter 936 may supply an RF pulse having a Larmor frequency to the RF coil 926, and the RF receiver 938 may receive an MR signal received by the RF coil 926.

The transmission/reception switch 934 may adjust a transmission/reception direction of each of the RF signal and MR signal. For example, in a transmission mode, the transmission/reception switch 934 may irradiate the RF signal on the object 910 through the RF coil 926, and in a reception mode, the transmission/reception switch 934 may receive the MR signal from the object 910 through the RF coil 926. The transmission/reception switch 934 may be controlled by a control signal from an RF controller 956.

The monitor 940 may monitor or control the gantry 920 or elements included in the gantry 920. The monitor 940 may include a system monitor 942, an object monitor 944, a table controller 946, and a display controller 948.

The system monitor 942 may monitor or control a state of a static magnetic field, a state of a gradient magnetic field, a state of an RF signal, a state of an RF coil, a state of a table, a state of an element that measures body information of an object, a power supply state, a state of a heat exchanger, a state of a compressor, etc.

The object monitor 944 monitors a state of the object 910. Specifically, the object monitor 944 may include a camera for observing a movement or position of the object 910, a breath measurer for measuring a breath of the object 910, an electrocardiogram (ECG) measurer for measuring an ECG of the object 910, or a body temperature measurer for measuring a body temperature of the object 910.

The table controller 946 controls a movement of the table 928 with the object 910 located thereon. The table controller 946 may control the movement of the table 928 according to sequence control by the sequence controller 950. For example, in capturing a moving image of an object, the table controller 946 may continuously or intermittently move the table 928 according to the sequence control by the sequence controller 950, and thus image the object at a view greater than a field of view (FOV) of a gantry.

The display controller 948 controls a plurality of displays which are respectively disposed outside and inside the gantry 920. Specifically, the display controller 948 may control turn-on/off of the displays disposed outside and inside the gantry 920, or control a screen displayed by each of the displays. Also, when a speaker is disposed inside or outside the gantry 920, the display controller 948 may control turn-on/off of the speaker or sound outputted by the speaker.

The system controller 950 may include a sequence controller 952 that controls a sequence of signals generated in the gantry 920 and a gantry controller 958 that controls the gantry 920 and elements mounted on the gantry 920.

The sequence controller 952 may include the gradient magnetic field controller 954 that controls the gradient amplifier 932 and the RF controller 956 that controls the RF transmitter 936, the RF receiver 938, and the transmission/reception switch 934. The sequence controller 952 may control the gradient amplifier 932, the RF transmitter 936, the RF receiver 938, and the transmission/reception switch 934 according to a pulse sequence received from the operation controller 960. The pulse sequence includes all information necessary to control the gradient amplifier 932, the RF transmitter 936, the RF receiver 938, and the transmission/reception switch 934, and for example, may include information on an intensity of a pulse signal applied to the gradient coil 924, an application time, and an application timing.

The operation controller 960 may provide pulse sequence information to the system controller 950, and control an overall operation of the MRI apparatus.

The operation controller 960 may include an image processor 962 that processes the MR signal received from the RF receiver 938, the controller 110, the user input receiver 120, the output unit 130, and an input unit 968.

The image processor 962 may process the MR signal received from the RF receiver 938 to generate an MRI image that is MRI image data of the object 910.

The image processor 962 may perform various signal processing operations, such as amplification, frequency conversion, phase detection, low-frequency amplification, and filtering, on the MR signal received by the RF receiver 938.

The image processor 962, for example, may arrange digital data in a k-space (e.g., referred to as a Fourier space or a frequency space) of a memory, and perform a 2D or 3D Fourier transform on the digital data to reconfigure the digital data into image data.

Moreover, depending on the case, the image processor 962 may perform a synthesis processing or differential operation processing on the image data. The synthesis processing may include an addition processing and a maximum intensity projection (MIP) processing on a pixel. Also, the image processor 962 may store image data, on which the synthesis processing or differential operation processing has been performed, in addition to the reconfigured image data, in a memory (not shown) or an external server.

Moreover, the image processor 962 may parallelly perform various signal processing on the MR signal. For example, the image processor 962 may parallelly perform signal processing on a plurality of MR signals received by a multi-channel RF coil to reconfigure the plurality of MR signals into image data.

The output unit 130 may output the image data generated or the image data reconfigured by the image processor 962 to a user. Also, the output unit 130 may output information (which is necessary for the user to manipulate the MRI apparatus) such as a user interface (UI), user information, or object information, in addition to the MRI image. The output unit 130 may include a speaker, a printer, a CRT display, an LCD, a PDP, an OLED display, an FED, an LED display, a VFD, a DLP display, a PFD, a 3D display, a transparent display, etc., and include various output devices within a scope obvious to those skilled in the art.

Moreover, the output unit 130 may display the slide bar 210 and the speed adjustment button 200 that is disposed at the first position of the slide bar 210.

The user input receiver 120 receives a certain input from a user. For example, the user input receiver 120 may receive a user's selection input for the speed adjustment button 200, and receive the user's drag input for the speed adjustment button 200. The user may perform the selection input and the drag input for the speed adjustment button 200 displayed by the output unit 130 by using a mouse, a trackball, a keyboard, or a touch screen.

The controller 110 may receive the drag input for the speed adjustment button 200 from the user, determine a search direction and a search speed for a plurality of medical images on the basis of the drag input, and search for the plurality of medical images according to the determined search direction and search speed.

The user may input object information, parameter information, a scanning condition, a pulse sequence, information on image synthesis or differential operation, etc. by using the input unit 968. The input unit 968 may include a keyboard, a mouse, a trackball, a voice recognizer, a gesture recognizer, a touch pad, a touch screen, etc., and include various input devices within a scope obvious to those skilled in the art.

FIG. 9 illustrates the signal transceiver 930, the monitor 940, the system controller 950, and the operation controller 960 as separate elements. However, those skilled in the art understand that respective functions performed by the signal transceiver 930, the monitor 940, the system controller 950, and the operation controller 960 may be performed by different elements. For example, it has been described above that the image processor 962 converts the MR signal received by the RF receiver 938 into a digital signal, but the conversion from the MR signal to the digital signal may be performed directly by the RF receiver 938 or the RF coil 926.

The gantry 920, the signal transceiver 930, the monitor 940, the system controller 950, and the operation controller 960 may be connected to each other in a wired/wireless manner. When they are connected in the wired manner, an element for synchronizing a clock therebetween may be further provided. Communication between the gantry 920, the signal transceiver 930, the monitor 940, the system controller 950, and the operation controller 960 may use a high-speed digital interface, such as low voltage differential signaling (LVDS), asynchronous serial communication such as a universal asynchronous receiver transmitter (UART), a low-delay network protocol such as synchronous serial communication or a can area network (CAN), or optical communication, and use various communication schemes within a scope obvious to those skilled in the art.

FIG. 10 is a diagram illustrating a configuration of a communicator 1000.

Referring to FIG. 10, the communicator 1000 may be connected to at least one of the gantry 920, the signal transceiver 930, the monitor 940, the system controller 950, and the operation controller 960 of FIG. 9.

The communicator 1000 may exchange data with a hospital server or a medical apparatus of a hospital which is connected thereto through a medical image information system, for example, PACS. Also, the communicator 1000 may perform data communication according to the digital imaging and communications in medicine (DICOM) standard.

As illustrated in FIG. 10, the communicator 1000 is connected to a network 1100 in a wired or wireless manner to communicate with an external server 1200, an external medical apparatus 1210, or an external portable device 1220. The communicator 1000 may transmit and receive data associated with a diagnosis of an object over a network 1100, and may also transmit and receive a medical image captured by a medical apparatus such as a computed tomography (CT) apparatus, a magnetic resonance imaging (MRI) apparatus, or an X-ray apparatus. Furthermore, the communicator 1000 may receive information on a diagnosis history or treatment schedule of a patient from a server, and use a diagnosis of an object. In addition, the communicator 1000 may perform data communication with the external portable device 1220, such as a portable terminal, a personal digital assistant (PDA), or a notebook computer of a doctor or a client, in addition to the external server 1200 or the external medical apparatus 1210 of a hospital.

Moreover, the communicator 1000 may transmit information about whether an MRI system is normal or information about a quality of a medical image to a user over the network 1100, and receive feedback of the transmitted information from the user.

The communicator 1000 may include one or more elements that enable communication with an external device, and for example, include a short-distance communicator 1010, a wired communicator 1020, and a mobile communicator 1030.

The short-distance communicator 1010 denotes a module for short-distance communication within a certain distance. Short-distance communication technology, according to an exemplary embodiment, may include wireless LAN, Wi-Fi, Bluetooth, ZigBee, Wi-Fi direct (WFD), ultra wideband (UWB), infrared data association (IrDA), Bluetooth low energy (BLE), and near field communication (NFC), but the short-distance communication technology is not limited thereto.

The wired communicator 1020 denotes a module for communication using an electrical signal or an optical signal. Wired communication technology according to an exemplary embodiment may include a pair cable, a coaxial cable, an optical fiber cable, or an Ethernet cable.

The mobile communicator 1030 transmits and receives a radio frequency (RF) signal to and from a base station, an external terminal, and a server over a mobile communication network. The RF signal may include various types of data based on transmission and reception of a voice call signal, a video call signal, or a letter/multimedia message.

The above-described exemplary embodiments may be written as computer programs and may be implemented in general-use digital computers that execute the programs using computer-readable recording media.

Examples of the computer-readable recording medium include magnetic storage media (e.g., ROM, floppy disks, hard disks, etc.) and optical recording media (e.g., CD-ROMs or DVDs).

The described-above exemplary embodiments and advantages are merely exemplary and are not to be construed as limiting. The present teaching can be readily applied to other types of apparatuses. The description of exemplary embodiments is intended to be illustrative, and not to limit the scope of the claims, and many alternatives, modifications, and variations will be apparent to those skilled in the art.

What is claimed is:

1. A method of displaying medical images, the method comprising:
displaying a slide bar including a speed adjustment button;
receiving a selection input and a drag input for the speed adjustment button from a user;
determining a search direction and a search speed for the medical images based on the drag input; and
searching for all or some of the medical images according to the determined search direction and search speed, and displaying the medical images which have been searched for.

2. The method of claim 1, wherein the determining the search direction and the search speed comprises:
when the speed adjustment button moves in a first direction according to the drag input, determining the search direction as a forward direction of an order in which the medical images are arranged; and
when the speed adjustment button moves in a second direction, determining the search direction as a reverse direction of the order in which the medical images are arranged.

3. The method of claim 1, wherein the determining the search direction and the search speed comprises:
receiving the drag input corresponding to moving the speed adjustment button disposed from a first position of the slide bar to a second position of the slide bar; and
determining the search speed based on a distance between the first position and the second position.

4. The method of claim 1, further comprising:
stopping searching for the medical images when the drag input ends.

5. The method of claim 1, further comprising:
displaying a first medical image of the medical images; and
overlapping and displaying a total number of the medical images and an order position at which the first medical image is arranged within the medical images, on the speed adjustment bar.

6. The method of claim 5, further comprising:
receiving an input of an arbitrary integer N from the user; and
displaying a medical image arranged at an Nth-order position within the medical images.

7. The method of claim 1, wherein the speed adjustment button includes a first sub-button and a second sub-button, and the method further comprises:
displaying a first medical image of the medical images;
receiving the user's selection input for the first sub-button or the second sub-button; and
displaying a second medical image arranged at a position preceding the first medical image within the medical images based on the user's selection input for the first sub-button, or displaying a third medical image arranged at a position subsequent to the first medical image within the medical images based on the user's selection input for the second sub-button.

8. The method of claim 2, wherein the first direction includes an up direction, a down direction, a left direction, or a right direction, and
the second direction includes a direction opposite to the first direction.

9. An apparatus for displaying medical images, the apparatus comprising:
a display apparatus that displays a slide bar including a speed adjustment button;
a user input receiver that receives a selection input and a drag input for the speed adjustment button from a user; and
a controller that determines a search direction and a search speed for the medical images based on the drag input, and controls the display apparatus to search for all or some of the medical images according to the determined search direction and search speed, and to display the medical images which have been searched for.

10. The apparatus of claim 9, wherein, when the speed adjustment button moves in a first direction according to the drag input, the controller determines the search direction as a forward direction of an order in which the medical images are arranged, and
when the speed adjustment button moves in a second direction, the controller determines the search direction as a reverse direction of the order in which the medical images are arranged.

11. The apparatus of claim 9, wherein the drag input indicates movement of the speed adjustment button from a first position of the slide bar to a second position of the slide bar, and
the controller determines the search speed based on a distance between the first position and the second position.

12. The apparatus of claim 9, wherein the display apparatus stops searching for the medical images when the drag input ends.

13. The apparatus of claim 9, wherein the display apparatus displays a first medical image of the medical images, and overlaps and displays a total number of the medical images and an order position in which the first medical image is arranged within the medical images, on the speed adjustment bar.

14. The apparatus of claim 9, wherein the apparatus receives an input of an arbitrary integer N from the user, and displays a medical image arranged at an Nth-order position within the medical images.

15. The apparatus of claim 9, wherein:
the speed adjustment button includes a first sub-button and a second sub-button, and
the apparatus displays a first medical image of the medical images, receives the user's selection input for the first sub-button or the second sub-button, and displays a second medical image arranged at a position preceding the first medical image within the medical images based on the user's selection input for the first sub-button, or displays a third medical image arranged at a position subsequent to the first medical image within the medical images based on the user's selection input for the second sub-button.

16. The apparatus of claim 10, wherein:
the first direction includes an up direction, a down direction, a left direction, or a right direction, and
the second direction includes a direction opposite to the first direction.

17. A non-transitory computer-readable storage medium storing a computer program which, when executed by a processor, causes the processor to execute the method of claim 1.
